(19) United States
(12) Patent Application Publication
(10) Pub. No.: US 2026/0337497 A1
(43) Pub. Date: Oct. 29, 2026

(54) SYSTEMS AND PROCESSES FOR TEMPERATURE CONTROL IN FLUIDIZED CATALYTIC CRACKING

(71) Applicants: T.EN PROCESS TECHNOLOGY INC., Houston, TX (US); SAUDI ARABIAN OIL COMPANY, Dhahran (SA); IFP ENERGIES NOUVELLES, Rueil-Mal maison Cedex (FR); AXENS, Rueil-malmaison (FR)

(72) Inventors: Scott GOLCZYNSKI, Houston, TX (US); Eusebius GBORDZOE, Houston, TX (US); Kenneth KRUG, Houston, TX (US); Md. Ashraful ISLAM, Dhahran (SA); Thibault JACQUEMIN, Rueil-Malmaison (FR); Jan VERSTRAETE, Solaize (FR); Allain FLORENT, Solaize (FR)

(21) Appl. No.: 19/107,341

(22) PCT Filed: Aug. 31, 2023
(86) PCT No.: PCT/US2023/031676

§ 371 Date: Feb. 27, 2025

Related U.S. Application Data
(60) Provisional application No. 63/374,240, filed on Aug. 31, 2022.

(51) Int. Cl. C10G 11/18; B01J 8/18; B01J 8/26; B01J 8/38

(52) U.S. Cl. CPC C10G 11/182; B01J 8/1836; B01J 8/26; B01J 8/388; C10G 2300/1044; C10G 2300/703

(57) ABSTRACT

A process for controlling catalyst temperature in a fluidized catalytic cracking (“FCC”) system includes regenerating a spent catalyst feed in a regenerator at a first temperature to produce a regenerated catalyst feed, withdrawing at least a portion of the re-generated catalyst feed to a reactor, and cooling the portion of the regenerated catalyst between an outlet of the regenerator and an inlet of the reactor. A fluidized catalytic cracking (“FCC”) system includes a catalyst regenerator configured and adapted to regenerate a spent catalyst feed at a first temperature to produce a regenerated catalyst, a reactor downstream from an outlet of the catalyst regenerator, a catalyst cooler between the outlet of the catalyst regenerator and an inlet of the reactor. The catalyst cooler is configured and adapted to cool at least a portion of a regenerated catalyst from the catalyst regenerator.

### CROSS-REFERENCE TO RELATED APPLICATIONS

The subject application claims the benefit of priority to U.S. Provisional Patent Application No. 63/374,240 filed Aug. 31, 2022, the disclosure of which is incorporated herein by reference in its entirety.

### BACKGROUND OF THE INVENTION

### 1. Field of the Invention

The present disclosure relates to fluidized catalytic cracking systems and processes and more particularly to downer fluid catalytic cracking systems and processes.

### 2. Description of Related Art

Fluidized catalytic cracking (“FCC”) processes are widely used for the conversion of hydrocarbon feed streams, such as vacuum gas oils and other relatively heavy oils, into lighter and more valuable hydrocarbon products. The basic components of a downer FCC system include at least one reactor, a spent catalyst riser, and a catalyst regenerator. In some cases, catalyst coolers are installed on the catalyst regenerator to control regenerator temperature within reasonable limits when processing heavy feedstocks. Several catalyst coolers have been installed on numerous FCC regenerators with traditional upflow riser reaction systems. The primary purpose in systems where the coolers are installed on the regenerators is to reject excess heat from the regenerator through steam production. Without the catalyst cooler, the regenerator will operate at higher than design temperature or the FCC unit throughput would be reduced to keep the regenerator temperature within the desired limits. There are other traditional processes for controlling the temperature of catalyst entering the regenerator from the stripper. This is generally applicable to FCC units operating at very high temperatures. Cooling the catalyst in the stripper reduces the particle temperature prior to the combustion process and thus eliminates catalyst de-activation from sintering.

These cooling techniques are described in a variety of U.S. Patents, for example, U.S. Pat. Nos. 5,209,287, 4,615,992, 5,571,482, 4,965,232, and 7,273,543. These patents describe systems that control either the regenerator temperature, or catalyst burning temperature, in the regenerator. To increase the catalyst-to-oil ratio and increase conversion, lowering the entire regenerator temperature could reduce the combustion efficiency and lead to inadequate regeneration producing regenerated catalyst with high catalyst coke content that reduces the catalyst activity.

The conventional techniques have been considered satisfactory for their intended purpose. However, there is an ever present need for improved catalyst cooling systems with improved catalyst-to-oil ratio and increased conversion, while preserving combustion efficiency. This disclosure provides a solution for this need.

### SUMMARY OF THE INVENTION

A process for controlling catalyst temperature in a fluidized catalytic cracking (“FCC”) system includes regenerating a spent catalyst feed in a regenerator at a first temperature to produce a regenerated catalyst feed, withdrawing at least a portion of the regenerated catalyst feed to a reactor, and cooling the portion of the regenerated catalyst between an outlet of the regenerator and an inlet of the reactor.

One or more embodiments include the process of any previous paragraph, and wherein the spent catalyst feed can include a light feed (LF) spent catalyst and a heavy feed (HF) spent catalyst.

One or more embodiments include the process of any previous paragraph, and wherein the reactor can be a HF reactor.

One or more embodiments include the process of any previous paragraph, and wherein the process can include providing the portion of the regenerated catalyst feed to a withdrawal well upstream from the reactor.

One or more embodiments include the process of any previous paragraph, and wherein cooling the portion of the regenerated catalyst can include cooling the portion of the regenerated catalyst with a catalyst cooler within the withdrawal well.

One or more embodiments include the process of any previous paragraph, and wherein the process can include providing the portion of the regenerated catalyst feed to a withdrawal well before the reactor, providing a second portion of the regenerated catalyst feed from the regenerator to a catalyst cooler before the reactor, and cooling the second portion of the regenerated catalyst in the catalyst cooler to generate a cooled second portion of the regenerated catalyst.

One or more embodiments include the process of any previous paragraph, and wherein cooling the portion of the regenerated catalyst can include cooling the portion of the regenerated catalyst in the withdrawal well by returning the cooled second portion from the catalyst cooler to the withdrawal well to generate a cooled regenerated catalyst.

One or more embodiments include the process of any previous paragraph, and wherein the process includes providing the portion of the regenerated catalyst feed to a withdrawal well before the reactor, providing a second portion of the regenerated catalyst from the withdrawal well to a catalyst cooler before the reactor, and cooling the second portion of the regenerated catalyst in the catalyst cooler to generate a cooled second portion of the regenerated catalyst.

One or more embodiments include the process of any previous paragraph, and wherein cooling the portion of the regenerated catalyst can include cooling the portion of the regenerated catalyst in the withdrawal well by returning the cooled second portion from the catalyst cooler to the withdrawal well to generate a cooled regenerated catalyst.

One or more embodiments include the process of any previous paragraph, and wherein the regenerator can be a common regenerator.

One or more embodiments include the process of any previous paragraph, and wherein regenerating the spent catalyst feed can include regenerating a LF spend catalyst and a HF spent catalyst in the common regenerator at the first regenerator operating temperature.

One or more embodiments include the process of any previous paragraph, and wherein cooling the portion of the regenerated catalyst can include cooling the portion of the regenerated catalyst to a second temperature lower than the first regenerator operating temperature.

In accordance with another aspect, a fluidized catalytic cracking (“FCC”) system includes a catalyst regenerator configured and adapted to regenerate a spent catalyst feed at a first temperature to produce a regenerated catalyst, a reactor downstream from an outlet of the catalyst regenerator, a catalyst cooler between the outlet of the catalyst regenerator and an inlet of the reactor. The catalyst cooler is configured and adapted to cool at least a portion of a regenerated catalyst from the catalyst regenerator.

One or more embodiments include the system of any previous paragraph, and wherein the reactor can be a HF reactor and wherein the outlet of the catalyst regenerator can be a first outlet.

One or more embodiments include the system of any previous paragraph, and wherein the system can include a second reactor downstream from a second outlet of the catalyst regenerator.

One or more embodiments include the system of any previous paragraph, and wherein the second reactor can be a LF reactor.

One or more embodiments include the system of any previous paragraph, and wherein a spent catalyst outlet of the LF reactor and a spent catalyst outlet of the HF reactor can both be in fluid communication with respective inlets of the catalyst regenerator, which can be a common regenerator.

One or more embodiments include the system of any previous paragraph, and wherein the reactor can be a HF reactor.

One or more embodiments include the system of any previous paragraph, and wherein the system can include a withdrawal well downstream from the catalyst regenerator and upstream from the reactor.

One or more embodiments include the system of any previous paragraph, and wherein the system can include a slide valve between the outlet of the catalyst regenerator and an inlet of the withdrawal well to control the regenerated catalyst entering the withdrawal well.

One or more embodiments include the system of any previous paragraph, and wherein the catalyst cooler can be separate from the catalyst regenerator.

One or more embodiments include the system of any previous paragraph, and wherein the catalyst cooler can be downstream from the withdrawal well.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic plan view of a fluidized catalytic cracking system having catalyst cooling in accordance with an embodiment of the present disclosure, showing catalyst cooling tubes in the withdrawal well;

FIG. 2 is a schematic plan view of a fluidized catalytic cracking system having catalyst cooling in accordance with another embodiment of the present disclosure, showing a catalyst cooler unit downstream from the regenerator; and

FIG. 3 is a schematic plan view of a fluidized catalytic cracking system having catalyst cooling in accordance with another embodiment of the present disclosure, showing a catalyst cooler unit downstream from the withdrawal well.

### DETAILED DESCRIPTION OF THE EMBODIMENTS

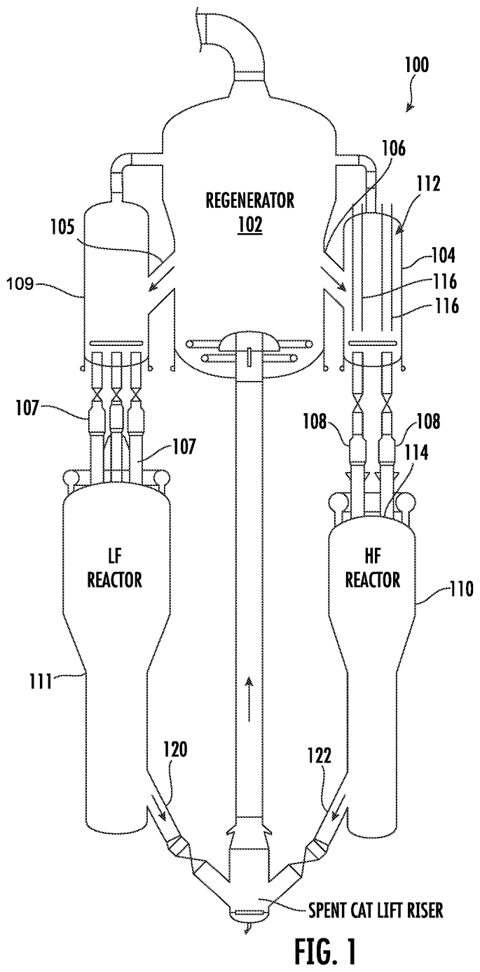

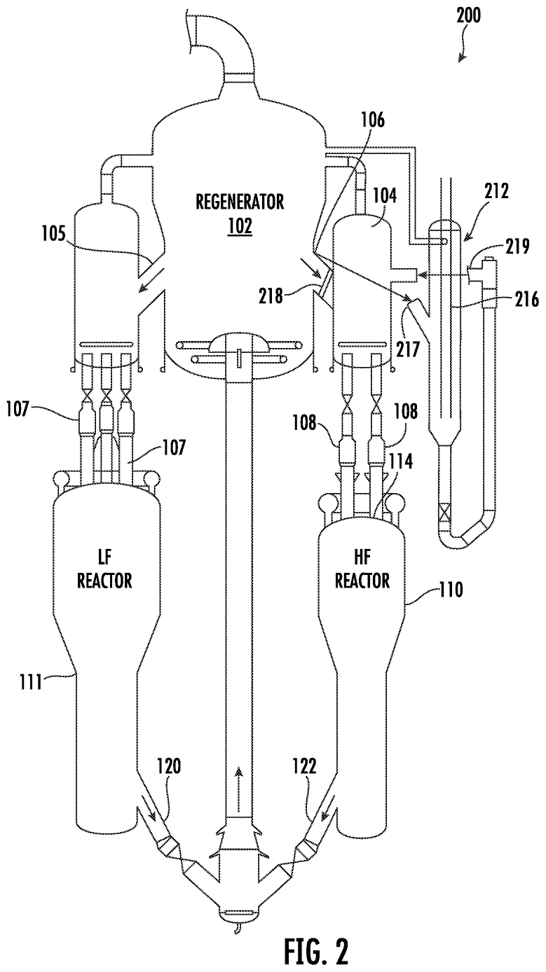

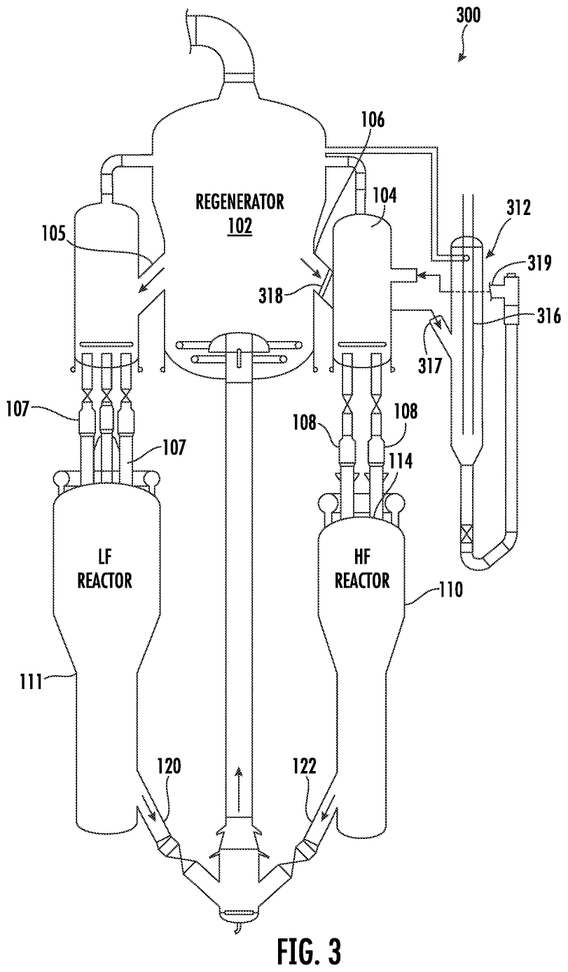

Reference will now be made to the drawings wherein like reference numerals identify similar structural features or aspects of the subject disclosure. For purposes of explanation and illustration, and not limitation, a schematic view of an exemplary embodiment of the fluidized catalytic cracking (FCC) system with a catalyst cooler in accordance with the disclosure is shown in FIG. 1 and is designated generally by reference character 100. Other embodiments of the FCC system in accordance with the disclosure, or aspects thereof, are provided in FIGS. 2-3 as will be described. The systems and methods described herein can be used to decouple the regenerator operation from regenerated catalyst temperature entering the heavy feed downers and allows the Cat/Oil in the heavy downers to be optimized, while still operating the regenerator at light feed system optimum temperature As shown in FIG. 1, a fluidized catalytic cracking (FCC) system 100, e.g., a high severity FCC (HS-FCC), includes a catalyst regenerator 102 configured and adapted to regenerate a spent catalyst feed at a first temperature to produce a regenerated catalyst.

System 100 includes a withdrawal well 104 downstream from a first outlet 106 of catalyst regenerator 102, multiple downer trains 108 processing Heavy Feed (HF) hydrocarbon feedstock in combination with regenerated catalyst from regenerator 102, and a reactor 110 downstream from downer trains 108. Reactor 110 is a heavy feed (HF) reactor. System 100 includes a second reactor 111, e.g., a light feed (LF) reactor, which processes LF hydrocarbon feedstock in combination with regenerated catalyst from regenerator 102. Second reactor 111 is downstream from a second outlet 105 of catalyst regenerator 102. In some embodiments, a withdrawal well 109 is positioned between second outlet 105 and LF reactor 111. A spent catalyst outlet 120 of LF reactor 111 and a spent catalyst outlet 122 of HF reactor 110 are both in fluid communication with catalyst regenerator 102, which is a common regenerator. System 100 includes a catalyst cooler 112 integrated into the withdrawal well 104 between outlet 106 of catalyst regenerator 102 and an inlet 114 of reactor 110. In the embodiment of system 100, catalyst cooler 112 includes catalyst cooling tubes 116 in withdrawal well 104. Catalyst cooler 112 is configured and adapted to cool at least a portion of a regenerated catalyst from catalyst regenerator 102. By providing cooling to the HF regenerated catalyst downstream from regenerator 102, regenerator 102 is allowed to operate at high temperature to meet the heat demand for cracking the LF while the regenerated catalyst temperature to the HF downers 108 is reduced.

With continued reference to FIG. 1, system 100 includes downer trains 107 and 108, each process different types of hydrocarbon feedstock, a light feed (LF) and heavy feed (HF), respectively. Downer trains 107 supply the LF to a LF reactor 111 and downer trains 108 supply the HF to HF reactor 110. The LF is very paraffinic and requires operating at much severe conditions such as catalyst-to-oil ratio of 30-40, e.g. 30, reactor outlet temperature (ROT) of 1160-1200 °F. The HF, on the other hand, behaves like a typical vacuum gas oil (VGO) or mild resid feedstock and requires operating at a lower severity of catalyst-to-oil ratio of 30-40, e.g. 30, and ROT of 1150-1160 °F. Because of the low overall coke make-up coupled with the high catalyst-to-oil ratio, regenerator 102 operates below 1300 °F. Usually, supplemental torch oil injection is used to keep the regenerator temperature optimized for the LF cracking. As such, installing a catalyst cooler on the regenerator itself to cool the catalyst to within the desired inlet temperature for HF reactor 110 would over cool the regenerator and reduce its regeneration effectiveness.

With reference now to FIG. 2, another embodiment of a FCC system 200, e.g., a HS-FCC, is the same as FCC system 100 of FIG. 1, except that fluidized catalytic cracking (FCC) system 200 includes a separate catalyst cooler 212. System 200 includes downer trains 107 and 108, which are the same as those in system 100. Similar to system 100, system 200 includes a catalyst regenerator 102, a withdrawal well 104 downstream from an outlet 106 of catalyst regenerator 102, multiple downer trains 108 processing feedstock from regenerator 102, and a reactor 110 downstream from downer trains 108. In the embodiment of system 200, catalyst cooler 212 is separate from the withdrawal well 104. Catalyst cooler 212 includes catalyst cooling tubes 216.

An inlet 217 of catalyst cooler 212 receives a second portion of the regenerated catalyst feed from regenerator 102 and cools the second portion. Once cooled, the cooled second portion is returned to withdrawal well 104 from outlet 219 of catalyst cooler 212 for mixing with a first portion of the regenerated catalyst feed entering withdrawal well 104 from outlet 106 of regenerator 102 to achieve the desired catalyst temperature to control the catalyst-to-oil ratio.

With continued reference to FIG. 2, system 200 includes a control valve 218, e.g. a slide valve, between regenerator 102 and withdrawal well 104. Slide valve 218 is installed to control the hot catalyst flow entering withdrawal well 104. System 200 offers more flexibility as compared with the embodiment of system 100, as slide valve 218 is used on an inlet of withdrawal well 104 to meter the amount of catalyst bypassing catalyst cooler 212 to achieve the desired catalyst temperature to downers 108. This configuration achieves a high degree of flexibility resulting in almost infinite control of the catalyst-to-oil ratio. Similar to system 100, providing cooling via catalyst cooler 212 to the HF regenerated catalyst downstream from regenerator 102, regenerator 102 is allowed to operate at high temperature to meet the heat demand for cracking the LF while the regenerated catalyst temperature to the HF downers 108 is reduced.

As shown in FIG. 3, another embodiment of a FCC system 300, e.g., a HS-FCC, is the same as FCC system 200 of FIG. 1, except that a separate catalyst cooler 312 of fluidized catalytic cracking (FCC) system 300 receives a second portion of HF regenerated catalyst, e.g. hot catalyst, from withdrawal well 104 at an inlet 317 of catalyst cooler 312, instead of directly from regenerator 102. Once cooled, the cooled second portion is returned to withdrawal well 104 from outlet 319 of catalyst cooler 312 for mixing with a first portion of the regenerated catalyst feed entering withdrawal well 104 from outlet 106 of regenerator 102 to achieve the desired regenerated catalyst temperature at the desired operating set point to control the catalyst-to-oil ratio.

Embodiments of the present disclosure, e.g. those shown in FIGS. 1-3, each include a catalyst cooler between the outlet of the catalyst regenerator and an inlet of the reactor, thereby decoupling the regenerator operation from catalyst temperature entering the HF downers and allows the catalyst-to-oil ratio in the HF downers to be optimized, while still operating the regenerator at LF system optimum temperature. While the embodiments herein are shown and described for a dual-downer unit, it is equally applicable to the HS-FCC single downer system as well.

In accordance with the embodiments of FIGS. 1-3, a process for controlling catalyst temperature in a FCC system, e.g. systems 100, 200 or 300, includes regenerating a spent catalyst feed in a regenerator, e.g. regenerator 102, at a first temperature to produce a regenerated catalyst feed, withdrawing at least a portion of the regenerated catalyst feed to a reactor, e.g. reactor 110, and cooling the portion of the regenerated catalyst in a catalyst cooler, e.g. catalyst cooler 112, 212, or 312 between an outlet, e.g. outlet 106, of the regenerator and an inlet, e.g. inlet 114, of the reactor. The regenerator is a common regenerator and regenerating the spent catalyst feed includes regenerating a light feed (LF) spent catalyst and a heavy feed (HF) spent catalyst in the common regenerator at the first temperature. The process includes providing the portion of the regenerated catalyst feed to a withdrawal well, e.g. withdrawal well 104, upstream from the reactor. Cooling the portion of the regenerated catalyst includes cooling the portion of the regenerated catalyst to a second temperature lower than the first regenerator operating temperature. In accordance with the embodiment of FIG. 1, cooling the portion of the regenerated catalyst includes cooling the portion of the regenerated catalyst with the catalyst cooler, e.g. catalyst cooler 112, within the withdrawal well.

In accordance with the embodiment of FIG. 2, the method includes providing a second portion of the regenerated catalyst feed from the regenerator to the catalyst cooler, e.g. catalyst cooler 212, before the reactor, and cooling the second portion of the regenerated catalyst in the catalyst cooler to generate a cooled second portion of the regenerated catalyst. In accordance with the embodiment of FIG. 2, cooling the portion of the regenerated catalyst includes cooling the portion of the regenerated catalyst in the withdrawal well by returning the cooled second portion from the catalyst cooler to the withdrawal well to generate a cooled regenerated catalyst.

In accordance with the embodiment of FIG. 3, the method includes providing a second portion of the regenerated catalyst from the withdrawal well to the catalyst cooler, e.g. catalyst cooler 312, before the reactor, and cooling the second portion of the regenerated catalyst in the catalyst cooler to generate a cooled second portion of the regenerated catalyst. In accordance with the embodiment of FIG. 3, cooling the portion of the regenerated catalyst includes cooling the portion of the regenerated catalyst in the withdrawal well by returning the cooled second portion from the catalyst cooler to the withdrawal well to generate a cooled regenerated catalyst.

The methods and systems of the present disclosure, as described above and shown in the drawings, provide for FCC systems and methods with superior properties including improved catalyst temperature control allowing the catalyst-to-oil ratio in the HF downers to be optimized, while still operating the regenerator at LF system optimum temperature. The systems and methods of the present invention can apply to HS-FCC dual-downer systems, HS-FCC single downer systems, or the like. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A process for controlling catalyst temperature in a fluidized catalytic cracking (“FCC”) system, the process comprising:
regenerating a spent catalyst feed in a regenerator at a first temperature to produce a regenerated catalyst feed;
withdrawing at least a portion of the regenerated catalyst feed to a reactor; and
cooling the portion of the regenerated catalyst between an outlet of the regenerator and an inlet of the reactor.

2. The process as recited in claim 1, wherein the spent catalyst feed includes a light feed (LF) spent catalyst and a heavy feed (HF) spent catalyst.

3. The process as recited in claim 1, wherein the reactor is a HF reactor.

4. The process as recited in claim 1, further comprising providing the portion of the regenerated catalyst feed to a withdrawal well upstream from the reactor, wherein cooling the portion of the regenerated catalyst includes cooling the portion of the regenerated catalyst with a catalyst cooler within the withdrawal well.

5. The process as recited in claim 1, further comprising providing the portion of the regenerated catalyst feed to a withdrawal well before the reactor, providing a second portion of the regenerated catalyst feed from the regenerator to a catalyst cooler before the reactor, and cooling the second portion of the regenerated catalyst in the catalyst cooler to generate a cooled second portion of the regenerated catalyst, wherein cooling the portion of the regenerated catalyst includes cooling the portion of the regenerated catalyst in the withdrawal well by returning the cooled second portion from the catalyst cooler to the withdrawal well to generate a cooled regenerated catalyst.

6. The process as recited in claim 1, further comprising providing the portion of the regenerated catalyst feed to a withdrawal well before the reactor, providing a second portion of the regenerated catalyst from the withdrawal well to a catalyst cooler before the reactor, and cooling the second portion of the regenerated catalyst in the catalyst cooler to generate a cooled second portion of the regenerated catalyst, wherein cooling the portion of the regenerated catalyst includes cooling the portion of the regenerated catalyst in the withdrawal well by returning the cooled second portion from the catalyst cooler to the withdrawal well to generate a cooled regenerated catalyst.

7. The process as recited in claim 1, wherein the regenerator is a common regenerator, wherein regenerating the spent catalyst feed includes regenerating a light feed (LF) spent catalyst and a heavy feed (HF) spent catalyst in the common regenerator at the first regenerator operating temperature.

8. The process as recited in claim 7, wherein cooling the portion of the regenerated catalyst includes cooling the portion of the regenerated catalyst to a second temperature lower than the first regenerator operating temperature.

9. A fluidized catalytic cracking (“FCC”) system, the system comprising:
a catalyst regenerator configured and adapted to regenerate a spent catalyst feed at a first temperature to produce a regenerated catalyst;
a reactor downstream from an outlet of the catalyst regenerator; and
a catalyst cooler between the outlet of the catalyst regenerator and an inlet of the reactor, wherein the catalyst cooler is configured and adapted to cool at least a portion of a regenerated catalyst from the catalyst regenerator.

10. The system as recited in claim 9, wherein the reactor is a HF reactor and wherein the outlet of the catalyst regenerator is a first outlet, the system further comprises a second reactor downstream from a second outlet of the catalyst regenerator.

11. The system as recited in claim 10, wherein the second reactor is a LF reactor, wherein a spent catalyst outlet of the LF reactor and a spent catalyst outlet of the HF reactor are both in fluid communication with respective inlets of the catalyst regenerator, which is a common regenerator.

12. The system as recited in claim 9, wherein the reactor is a HF reactor.

13. The system as recited in claim 9, further comprising a withdrawal well downstream from the catalyst regenerator and upstream from the reactor.

14. The system as recited in claim 13, further comprising a slide valve between the outlet of the catalyst regenerator and an inlet of the withdrawal well to control the regenerated catalyst entering the withdrawal well.

15. The system as recited in claim 13, wherein the catalyst cooler is separate from the catalyst regenerator.

16. The system as recited in claim 13, wherein the catalyst cooler is downstream from the withdrawal well.
